(19) United States
(12) Patent Application Publication
(10) Pub. No.: US 2007/0158381 A1
(43) Pub. Date: Jul. 12, 2007

(54) Method and device for breaking scored glass sheets

(76) Inventor: Peter Lisec, Amstetten-Hausmening (AT)

Correspondence Address: YOUNG & THOMPSON, 745 SOUTH 23RD STREET, 2ND FLOOR, ARLINGTON, VA, 22202, US

(21) Appl. No.: 10/578,365

(22) PCT Filed: Nov. 6, 2003
(86) PCT No.: PCT/AT03/00331

§ 371 Date: Mar. 26, 2007

(51) Int. Cl. B26F 3/00

(52) U.S. Cl. 225/2; 225/96.5

(57) ABSTRACT

A glass breaking table includes two rows of suction pads, on either side of a gap between table platforms. A breaking strip in the gap can be raised. A pressure tool including two fingers is provided above one end of the gap. A glass sheet is held on either side of the gap by negative pressure to the suction pads and is pre-tensioned in a convex manner, (the convex face of the sheet having a scored line), with the aid of the breaking strip, which can be raised uniformly along the entire length of the glass sheet in the vicinity of the scored line. The pressure tool exerts a pressure from above only in the vicinity of one end of the scored line in the edge region of the sheet on both sides of the scored line, initiating the breaking of the pre-tensioned glass sheet along the scored line.

The invention relates to a process with the features of the introductory part of the claim 1.

The invention furthermore relates to a device with which glass sheets, after they have been scored, can be broken.

Devices for breaking glass sheets are known from U.S. Pat. No. 5,857,603 A (=EP 0 564 758 A) and from U.S. Pat. No. 5,165,585 A (=EP 0 457 751 A).

The problem in the known devices for breaking glass sheets (breaking tables) is that breaking of thick glass sheets, therefore glass sheets with a thickness of for example more than 8 mm, regardless of whether it is flat glass or laminated glass with at least one thicker glass sheet, is a problem. It is particularly problematical if with the known devices narrow strips are to be separated from these glass sheets or laminated glass panes.

The object of the invention is to develop the known breaking processes such that even thick glass sheets can be easily broken.

This object is achieved as claimed in the invention with a process which has the features of claim 1.

To the extent the device is concerned, the object underlying the invention is achieved with the features of the main apparatus claim.

Preferred and advantageous embodiments of the process as claimed in the invention on the one hand and the device as claimed in the invention on the other hand are the subject matter of the dependent claims.

Since in the process as claimed in the invention a glass sheet in the area of its scored line is pretensioned by holding it down on either side of the scored line and by applying pressure to the side opposite the scored line over the entire length of this scored line for purposes of arching of the glass pane with the scored line located on the “convex” side, and pressure is additionally applied preferably in spots to the “convex” side, therefore the side of the glass sheet on which the scored line lies, in the area of one end of this scored line, therefore in the area of one edge of the glass sheet to the latter on the two sides of the scored line, it is possible to easily separate even thick glass sheets and/or narrow strips from glass sheets.

This also takes place when the glass sheets are held down by applying a negative pressure using suction heads on either side of the scored line and when pressure is applied to the glass pane on the side opposite the scored line by a breaking strip.

Pretensioning of the glass sheet for the purpose of arching (even if in this way the glass sheet is essentially not “arched) and the additional application of pressure to the glass pane (only) in the area of one end of the scored line and on either side of the scored line along which the glass pane is to be opened are advantageous for one preferred embodiment of the process as claimed in the invention. Thus a break along the scored line is initiated.

The additional pressure can be applied after the glass sheet has been pretensioned over the entire length of the scored line for the purposes of arching. The pressure for initiating the break can also be applied during pretensioning, especially in the last segment of pretension.

To the extent the device is concerned, the construction is simple since normal glass cutting tables with suction heads for holding down the glass pane, which suction heads are generally embedded into the support surface of the glass cutting table, and with a raisable breaking strip located between the suction heads need only be equipped with one tool for applying pressure in the edge area of the glass sheet/of the laminated glass.

This tool for applying pressure to one end of the scored line and on either side of it, therefore on either side of the end of the scored line in the area of the edge of one glass sheet/laminated glass pane, is for example a tool made fork-shaped with two fingers which can be placed against the glass sheet for applying pressure.

The free ends of the tool, especially of the fingers, which engage the glass pane, can be equipped with elastic, for example partially cylindrical bodies.

It is also advantageous if the essentially fork-shaped tool for applying pressure is pivotally supported, and it can be provided that it is kept in the neutral position by spring force.

Other details and features of the process as claimed in the invention and the device of the invention will become apparent from the following description using the drawings.

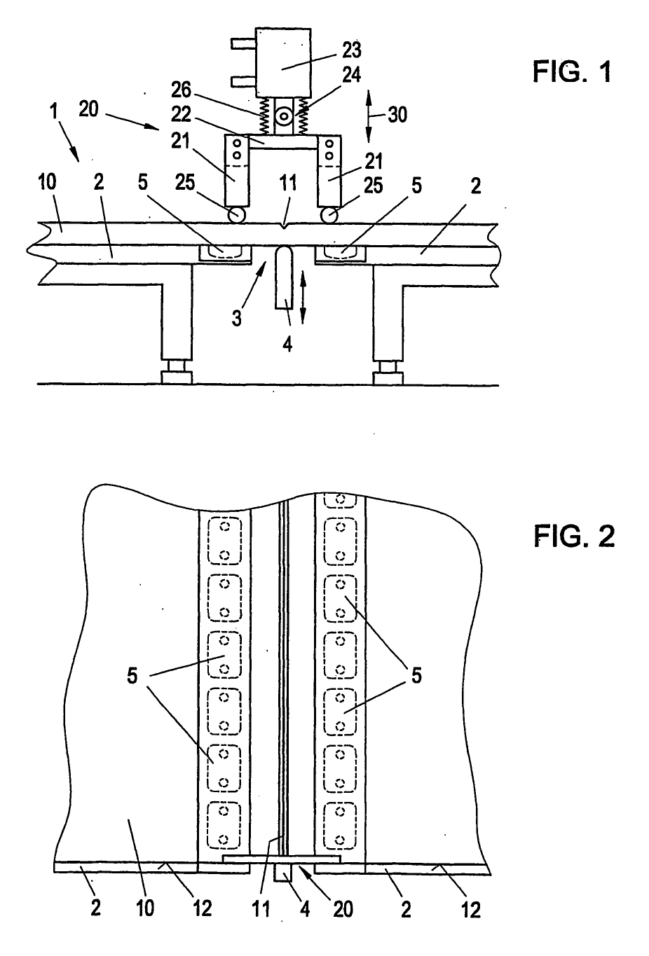

FIG. 1 schematically shows in a side view a glass cutting table (partially); and

FIG. 2 shows a top view to FIG. 1.

As is shown in FIG. 1, the glass cutting table 1 consists of a frame which is not detailed, with two table plates 2 between which there is a gap 3. In the gap 3 there is breaking strip 4 which can be vertically adjusted by a drive which is not detailed in order to apply pressure from underneath to a glass sheet 10 (or laminated glass) which is lying on the glass cutting table 1 and in which there is a scored line 11 (the scored line 11 lies on the top of the glass sheet 10).

In the area of the edges of the table plates 2 which are adjacent to the gap 3, there are two rows of suction heads 5 to hold the glass sheet 10 on either side of the scored line 11 from underneath by applying a negative pressure when the breaking strip 4 is raised.

Above the table plate 2, in the area of one end of the gap 3 there is a tool 20 for applying pressure to the top of the glass sheet 10 on either side of the scored line 11. This tool 20 is located in the area of one edge 12 of the glass sheet 10, therefore in the area of one end of the scored line 11 in the glass sheet 10.

Optionally the tool 20 can be adjustable in order to be able to align it relative to the edge 12 of a glass sheet 10. To do this, the tool 20 can be moved on a cutting bridge which is not shown and which is conventionally a component of glass cutting tables. It is preferable if the tool 20 is attached to a carriage which also bears the cutting head for scoring the glass sheet/laminated glass.

The breaking strip 4 can be raised uniformly over its entire length, so that it uniformly applies pressure from underneath to the glass sheet 10 over the entire length of the scored line 11.

When a glass sheet 10 is broken along the scored line 11 produced beforehand by it for example the procedure is as described below:

First of all, a glass sheet 10 is aligned on the cutting table 1 such that its scored line 11 which is optionally still to be produced comes to rest exactly over the breaking strip 4. Then the suction heads 5 which are located underneath the glass sheet 10 are exposed to a negative pressure so that the glass sheet 10 is held in the area of the two rows of suction heads 5, therefore on either side of the gap 3. At this point the lifting strip 4 is raised uniformly over its entire length so that the glass sheet 10 is pretensioned for purposes of arching. The pretensioning takes place such that the scored line 11 lies on the “convex” side of the glass sheet 10, in the illustrated exemplary embodiment the top of the glass sheet 10. As soon as the pretensioning has reached the desired value (the extent of pretensioning is determined by the holding force of the suction heads 5) the pressure tool 20 is lowered in the direction of the double arrow 30 by a linear motor 23 and its fingers 21 with their ends equipped with elastic bodies 25 come into contact with the side of the glass sheet 10 in which the scored line 11 is present. The elastic bodies 25 for example at least in their area pointing down in which they come into contact with the glass sheet 10 have a cylindrical outside outline. The break of the above described pretensioned glass sheet 10 is initiated by the pressure applied by the fingers 21 of the pressure tool 20 to the top of the glass sheet 10 in the area of the end of the scored line 11 produced [by] it, especially essentially in spots, on the two sides of the scored line 11 and the glass sheet 10 breaks cleanly along the scored line 11.

FIG. 1 shows that the pressure tool 20 is connected to the piston of the linear motor 23 via a joint 24. This ensures that the two fingers 21 via their elastic bodies 25 on either side of the scored line 11 apply pressure uniformly to the glass sheet 10. In doing so it can also be provided that a spring 26 is assigned to the joint 24 and provides for the crosspiece 22 of the pressure tool 20 being aligned essentially horizontally when the tool 20 is not placed on a glass table 10.

The fingers 21 can be adjustable located on the crosspiece 22 of the tool 20 so that they can be adjusted and matched according to the given conditions.

The device as claimed in the invention and the process as claimed in the invention can be used for dividing (“cutting”) flat glass and laminated glass.

In summary one exemplary embodiment of the invention can be described as follows:

To break the glass sheets 10, especially thick glass sheets, in the glass cutting table 1 on either side of a gap 3 between the table plates 2 there are two rows of suction heads 5. There is a breaking strip 4 in the gap 3 with a lifting capacity. Above the gap 3 on one of its ends there is a pressure tool 20 with two fingers 21. By applying negative pressure to the suction heads 5 a glass sheet 2 is held on either side of the gap 3 and pretensioned using a lifting strip 4 which is uniformly raised over the entire length of the glass sheet 10 in the area of the scored line 11, for purposes of arching with the scored line 11 located on the “convex” side of the arch. Only in the area of one end of the scored line 11 is pressure applied by the pressure tool 20 from the top to the glass sheet 10 which has been pretensioned in this way in its edge area 12 on either side of the scored line and in this way breaking of the pretensioned glass sheet 10 along the scored line 11 is initiated.

1. Process for dividing a glass sheet (10) along a scored line (11) produced in it, in which the glass sheet (10) is arched by holding it down on either side of the scored line (11) and by applying pressure to the side of the glass sheet (10) opposite the scored line (11) over the entire length of this scored line (11) with a scored line (11) located on the “convex” side of the glass sheet (10), characterized in that the glass sheet (10) is pretensioned by arching with a scored line (11) located on the convex side of the arch of the glass sheet (10), and that breaking of the glass sheet (10) pretensioned in this way is initiated along the scored line (11) by pressure being applied on either side of the scored line (11) only in the area of one end of the scored line (11) to the side of the glass sheet (10) in which there scored line (11) is provided.

2. Process as claimed in claim 1, wherein the glass sheet (10) is pretensioned in that the glass sheet (10) is held down on either side of the scored line (11) by suction heads (5) supplied with negative pressure and from the side of the glass sheet (10) opposite the scored line (11) pressure is applied to the glass sheet (10) via a breaking strip (4), the direction of the pressure applied by the breaking strip (4) being opposite the direction of action of the suction heads (5).

3. Process as claimed in claim 1 or 2, wherein pressure is applied to the pretensioned glass sheet (10) in the area of its edge (12) using a pressure tool with two pressure fingers (21)) to initiate breaking.

4. Process as claimed in claim 2, wherein uniform pressure is applied to the glass sheet (10) by the breaking strip (4) over the entire length of the scored line (11).

5. Device for carrying out the process as claimed in claim 1, with a support (2) for a glass sheet (10) to be divided, in which there is a scored line (11), with hold-down devices (5) provided in the area of a gap (3) between the supports (11) and with a breaking strip (4) provided in the gap (3) wherein there is a pressure tool (20) which in the area of one end of the scored line (11) of the glass sheet (10) applies pressure to one side of the glass sheet (10) in which the scored line (11) is provided.

6. Device as claimed in claim 5, wherein the pressure tool (20) is made essentially fork-shaped with two fingers (21) directed at the glass sheet (10).

7. Device as claimed in claim 6, wherein the fingers (21) are provided on their free ends with bodies (25) of elastic material.

8. Device as claimed in claim 5, wherein the pressure tool (20) can be adjusted in the direction which is normal (arrow 30) to the support surface (2) the glass sheet (10) using a linear motor (23).

9. Device as claimed in claim 8, wherein the pressure tool (20) is located on the piston of the linear motor (23) with a pivoting capacity (24).

10. Device as claimed in claim 9, wherein there is a spring (26) which keeps the pressure tool (20) in its neutral position.

11. Device as claimed in claim 6, wherein the fingers (21) of the pressure tool (20) are adjustably attached to a crosspiece (23).

12. Device as claimed in claim 5, wherein the devices for holding down the glass sheet on the support surface (2) are suction heads (5) provided on either side of the gap (3) between the supports (2).

13. Device as claimed in claim 5, wherein the pressure tool (20) can be adjusted in the direction of the scored line (11) and of the gap (3) between the supports (2).

14. Process as claimed in claim 2, wherein pressure is applied to the pretensioned glass sheet (10) in the area of its edge (12) using a pressure tool with two pressure fingers (21)) to initiate breaking.

15. Process as claimed in claim 3, wherein uniform pressure is applied to the glass sheet (10) by the breaking strip (4) over the entire length of the scored line (11).

16. Device for carrying out the process as claimed in claim 2, with a support (2) for a glass sheet (10) to be divided, in which there is a scored line (11), with hold-down devices (5) provided in the area of a gap (3) between the supports (11) and with a breaking strip (4) provided in the gap (3) wherein there is a pressure tool (20) which in the area of one end of the scored line (11) of the glass sheet (10) applies pressure to one side of the glass sheet (10) in which the scored line (11) is provided.

17. Device for carrying out the process as claimed in claim 3, with a support (2) for a glass sheet (10) to be divided, in which there is a scored line (11), with hold-down devices (5) provided in the area of a gap (3) between the supports (11) and with a breaking strip (4) provided in the gap (3) wherein there is a pressure tool (20) which in the area of one end of the scored line (11) of the glass sheet (10) applies pressure to one side of the glass sheet (10) in which the scored line (11) is provided.

18. Device for carrying out the process as claimed in claim 4, with a support (2) for a glass sheet (10) to be divided, in which there is a scored line (11), with hold-down devices (5) provided in the area of a gap (3) between the supports (11) and with a breaking strip (4) provided in the gap (3) wherein there is a pressure tool (20) which in the area of one end of the scored line (11) of the glass sheet (10) applies pressure to one side of the glass sheet (10) in which the scored line (11) is provided.

19. Device as claimed in claim 6, wherein the pressure tool (20) can be adjusted in the direction which is normal (arrow 30) to the support surface (2) the glass sheet (10) using a linear motor (23).

20. Device as claimed in claim 7, wherein the pressure tool (20) can be adjusted in the direction which is normal (arrow 30) to the support surface (2) the glass sheet (10) using a linear motor (23).
